(19) United States
(12) Patent Application Publication
(10) Pub. No.: US 2013/0295386 A1
(43) Pub. Date: Nov. 7, 2013

(54) WATERPROOF PIGMENT, PREPARING METHOD AND USE THEREOF

(71) Applicants: Jiansheng Fu, Shantou (CN); Fen Long, Shantou (CN); Junli Zhang, Shantou (CN)

(72) Inventors: Jiansheng Fu, Shantou (CN); Fen Long, Shantou (CN); Junli Zhang, Shantou (CN)

(73) Assignee: SHANTOU LONGHUA PEARL LUSTRE PIGMENTS CO., LTD, Shantou, Guangdong (CN)

(21) Appl. No.: 13/980,054

(22) PCT Filed: Jun. 3, 2011
(86) PCT No.: PCT/CN2011/075248

§ 371 Date: Jul. 17, 2013

(30) Foreign Application Priority Data
Jan. 17, 2011 (CN) 201110009246.1

(51) Int. Cl. C09D 5/38

(52) U.S. Cl. CPC C09D 5/38
USPC 428/403; 427/214

(57) ABSTRACT

A waterproof pigment, the preparing method and the use thereof are provided. The pigment has a primary flake with a layered structure of at least three layers including a top layer, an assembled intermediate layer and a bottom layer, wherein the assembled intermediate layer has at least one layer of active metal. The pigment has a coating on the side of the primary flake only.

### FIELD OF THE INVENTION

The present invention relates to a pigment containing active metal, and particularly to a waterproof pigment containing active metal, the preparing method and the use thereof.

### BACKGROUND OF THE INVENTION

It is well known that the reaction between aluminum and water is an oxidation-reduction reaction, generating an alumina film on the aluminum surface and releasing hydrogen gas at the same time. Due to a large specific surface area, an aluminum pigment will cause a drastic reaction and release large amounts of hydrogen gas when it is used for water-based coating products, for this reason, uncoated aluminum pigment cannot be well used for waterborne coating products and printing ink.

To enable the aluminum pigment to be available for waterborne coating products and paint, a post-processing, i.e. a coating process, is thus required for the aluminum pigment. In this coating process, the surface of aluminum pigment is coated with one or more layer of inert compounds, for example, the aluminum pigment is compactly encapsulated in a silicon dioxide layer. This kind of coating is called “bag-like encapsulation”, it refers to a complete coating of all sides of the aluminum pigment with silicon dioxide, which is somewhat like putting aluminium powder into a bag. In this way, the aluminium powder can be completely separated from water, thereby preventing contact between the surface of aluminum pigment particles and water, preventing the oxidation-reduction reaction of aluminum, and facilitating the use of aluminum pigment in waterborne coating products and paint.

To achieve certain optical effects or other desired effects, some special pigments are provided, they have naked aluminum surface. This kind of pigment can be, for example, a composite pigment with “sandwich” structure, the pigment particle has one or more layer of metallic aluminum in the middle thereof, the aluminum layer can be very thin with the thickness just being a few tens of nanometers. Due to quantum effect, the oxidation-reduction reaction between the thin aluminum layer and water can be instantaneous and strong, releasing large amounts of hydrogen gas and resulting in great risk during the process of transportation, storage, and using. This is especially important when the aluminum pigment is used for waterborne coating products, paint and printing ink, because the generation of hydrogen gas may cause safety issues during operation, or it may affect the quality of coating and ink printing.

Limited by preparing method, or due to the special effect given by the “sandwich” structure itself, the sandwich-structured pigment having special effect cannot be applied with “bag-like encapsulation” which is widely applied for pearlescent pigment.

If the “bag-like encapsulation” is applied on the sandwich-structured special pigments, such as by using silicon dioxide, the optical effect of the special pigments would be changed due to different refractive index of different material, what's worse, the special pigment would obtain other optical effects instead of their original effect.

### SUMMARY OF THE INVENTION

An object of the present invention is to provide a waterproof and sandwich-structured pigment which contains active metal and has special effect.

The object of the present invention can be achieved by the following technical solution: a waterproof pigment having a primary flake, with the primary flake having a layered structure of at least three layers including a top layer, an assembled intermediate layer and a bottom layer, and the assembled intermediate layer having at least one active metal layer, the waterproof pigment has a coating only on the side of the primary flake. In a preferred embodiment of the present invention, the waterproof pigment has a coating only on the side of the active metal layer.

The pigment of the present invention employs a ring-shaped coating, in this way, only the metal surface of the metal layer of the sandwich- structured pigment is coated. By using this kind of coating, the metal surface can be completely separated from water, thereby preventing the oxidation-reduction reaction and the generation of hydrogen gas; additionally, the optical property of the special pigment with “sandwich” structure will not be influenced. The primary flake of the present invention can be Bright Siver pigment (produced by JDSU in USA, SpectraFlair®).

In a preferred embodiment of the waterproof pigment of the present invention, the active metal layer of the waterproof pigment is an aluminum layer or a copper layer.

In a preferred embodiment of the waterproof pigment of the present invention, the coating is one selected from the group consisting of fatty acids, salts of fatty acids, amino acids, salts of amino acids, phosphate esters, salts of phosphate esters, polybasic weak acids, salts of polybasic weak acids and organic silicon compounds. More preferably, the coating is one selected from the group consisting of sulfonates, alkyl sulfonates, polysulfonic acids, phosphoric acids, phosphates and polyphosphoric acids.

In a preferred embodiment of the waterproof pigment of the present invention, the coating is one selected from the group consisting of tin tetrachloride, stannous chloride, zirconium oxychloride, sodium silicate, sodium aluminate, aluminum chloride, bismuth nitrate, calcium chloride and magnesium chloride.

The present invention also provides a process of preparing a waterproof pigment, comprising the steps of:
(1) mixing 70-100 parts by volume of water with 5-40 parts by volume of alcohol or ether homogeneously to obtain a mixture A;
(2) adding a coating agent to the mixture A with the amount of coating agent being between 5 percent and 15 percent by weight of the mixture A, then completely dissolving the coating agent to obtain a mixture B;
(3) heating the mixture B to a temperature of between 25° C. and 45° C. , and adjusting pH to a level of between 7 and 9, then adding a primary flake to the mixture B with the amount of primary flake being between 1 percent by weight and 5 percent by weight of the mixture B, and reacting for 0.5-6 hours;
(4) filtering and drying the product of step (3) to obtain the waterproof pigment; wherein the primary flake has a layered structure of at least three layers, including a top layer, an assembled intermediate layer and a bottom layer, and the assembled intermediate layer has at least one active metal layer. The metal layer is an aluminum layer or a copper layer.

In the process of the present invention, only compounds that can be selectively adsorbed onto or reacted with aluminum layer or copper layer are selected, these compounds can be adsorbed only on the metal surface of the metal layer of the sandwich-structured special pigment, after adsorption, these compounds can be reacted with the metal to form a ring-shaped coating structure. In this way, the metal surface can be completely separated from water, thereby preventing the oxidation-reduction reaction and the generation of hydrogen gas. Because the compounds don't react with the top layer or the bottom layer of the flaky sandwich-structured pigment, the optical property of the pigment will not be influenced by the coating. Furthermore, these compounds have certain dispersing property in water, which enable the special pigments with ring-shaped coating to be available for waterborne coating products, paint and printing ink.

The primary flake of the present invention can be Bright Siver pigment (produced by JDSU in USA, SpectraFlair®).

In a preferred embodiment of the process of the present invention, the coating is one selected from the group consisting of fatty acids, salts of fatty acids, amino acids, salts of amino acids, alkyl sulfonates, phosphate esters, salts of phosphates, polybasic weak acids, salts of polybasic weak acids and organic silicon compounds. More preferably, the coating is one selected from the group consisting of sulfonates, polysulfonic acids, phosphoric acids, phosphates and polyphosphoric acids.

In a preferred embodiment of the process of the present invention, the coating is one selected from the group consisting of tin tetrachloride, stannous chloride, zirconium oxychloride, sodium silicate, sodium aluminate, aluminum chloride, bismuth nitrate, calcium chloride and magnesium chloride.

The present invention also provides the use of a waterproof pigment for the preparing of a water-based coating products, paint or printing ink.

### DETAILED DESCRIPTION OF THE PREFERRED EMBODIMENTS OF THE INVENTION

The present invention will be more fully understood and appreciated from the following detailed description.

### EXAMPLE 1

A process of preparing a waterproof pigment, comprising the steps of:
(1) mixing 70 parts by volume of water with 5 parts by volume of ethanediol homogeneously to obtain a mixture A;
(2) adding a coating agent sodium silicate to the mixture A with the amount of sodium silicate being 5 percent by weight of the mixture A, then completely dissolving the sodium silicate to obtain a mixture B;
(3) heating the mixture B to a temperature of 25° C., and adjusting pH to a level of 7, then adding a primary flake to the mixture B with the amount of primary flake being 1 percent by weight of the mixture B, and reacting for 0.5 hour;
(4) filtering the product of step (3) to obtain the waterproof pigment;

wherein the primary flake has a layered structure of three layers, including a top layer, an assembled intermediate layer and a bottom layer, the assembled intermediate layer is an aluminum layer.

### EXAMPLE 2

A process of preparing a waterproof pigment, comprising the steps of:
(1) mixing 100 parts by volume of water with 40 parts by volume of isoamyl alcohol homogeneously to obtain a mixture A;
(2) adding a coating agent sodium dodecyl sulfate to the mixture A with the amount of sodium dodecyl sulfate being 15 percent by weight of the mixture A, then completely dissolving the sodium dodecyl sulfate to obtain a mixture B;
(3) heating the mixture B to a temperature of 45° C., and adjusting pH to a level of 9, then adding a primary flake to the mixture B with the amount of primary flake being 5 percent by weight of the mixture B, and reacting for 2 hours;
(4) filtering the product of step (3) to obtain the waterproof pigment;

wherein the primary flake has a layered structure of five layers, including a top layer, an assembled intermediate layer and a bottom layer, the assembled intermediate layer has an aluminum layer and a copper layer.

### EXAMPLE 3

A process of preparing a waterproof pigment, comprising the steps of:
(1) mixing 80 parts by volume of water with 20 parts by volume of diethyl ether homogeneously to obtain a mixture A;
(2) adding a coating agent silane to the mixture A with the amount of silane being 10 percent by weight of the mixture A, then completely dissolving silane to obtain a mixture B;
(3) heating the mixture B to a temperature of 30° C., and adjusting pH to a level of 8, then adding a primary flake to the mixture B with the amount of primary flake being 2 percent by weight of the mixture B, and reacting for 1 hour;
(4) filtering the product of step (3) to obtain the waterproof pigment;

wherein the primary flake has a layered structure of three layers, including a top layer, an assembled intermediate layer and a bottom layer, the assembled intermediate layer is a copper layer.

### EXAMPLE 4

A process of preparing a waterproof pigment, comprising the steps of:
(1) mixing 90 parts by volume of water with 20 parts by volume of propylene glycol homogeneously to obtain a mixture A;
(2) adding a coating agent sodium dihydrogen phosphate to the mixture A with the amount of sodium dihydrogen phosphate being 8 percent by weight of the mixture A, then completely dissolving sodium dihydrogen phosphate to obtain a mixture B;
(3) heating the mixture B to a temperature of 30° C., and adjusting pH to a level of 7.5, then adding a primary flake to the mixture B with the amount of primary flake being 3 percent by weight of the mixture B, and reacting for 1.5 hours;
(4) filtering the product of step (3) to obtain the waterproof pigment;

wherein the primary flake has a layered structure of five layers, including a top layer, an assembled intermediate layer and a bottom layer, the assembled intermediate layer has two aluminum layers.

### EXAMPLE 5

A process of preparing a waterproof pigment, comprising the steps of:
(1) mixing 85 parts by volume of water with 38 parts by volume of hexadecanediol homogeneously to obtain a mixture A;
(2) adding a coating agent sodium glutamate to the mixture A with the amount of sodium glutamate being 12 percent by weight of the mixture A, then completely dissolving sodium glutamate to obtain a mixture B;
(3) heating the mixture B to a temperature of 25° C., and adjusting pH to a level of 8.5, then adding a primary flake to the mixture B with the amount of primary flake being 4 percent by weight of the mixture B, and reacting for 4 hours;
(4) filtering and drying the product of step (3) to obtain the waterproof pigment;

wherein the primary flake is Bright Siver pigment (produced by JDSU in USA, SpectraFlair®).

### EXAMPLE 6

A process of preparing a waterproof pigment, comprising the steps of:
(1) mixing 89 parts by volume of water with 30 parts by volume of palmityl alcohol homogeneously to obtain a mixture A;
(2) adding a coating agent lecithin to the mixture A with the amount of lecithin being 6 percent by weight of the mixture A, then completely dissolving lecithin to obtain a mixture B;
(3) heating the mixture B to a temperature of 35° C., and adjusting pH to a level of 8.3, then adding a primary flake to the mixture B with the amount of primary flake being 5 percent by weight of the mixture B, and reacting for 1 hour;
(4) filtering and drying the product of step (3) to obtain the waterproof pigment;

wherein the primary flake is Bright Siver pigment (produced by JDSU in USA, SpectraFlair®).

### EXAMPLE 7

A process of preparing a waterproof pigment, comprising the steps of:
(1) mixing 90 parts by volume of water with 40 parts by volume of glycerol homogeneously to obtain a mixture A;
(2) adding a coating agent stannous chloride to the mixture A with the amount of stannous chloride being 15 percent by weight of the mixture A, then completely dissolving stannous chloride to obtain a mixture B;
(3) heating the mixture B to a temperature of 45° C., and adjusting pH to a level of 9, then adding a primary flake to the mixture B with the amount of primary flake being 4.5 percent by weight of the mixture B, and reacting for 5 hours;
(4) filtering and drying the product of step (3) to obtain the waterproof pigment;

wherein the primary flake has a layered structure of three layers, including a top layer, an assembled intermediate layer and a bottom layer, the assembled intermediate layer is an aluminum layer.

### EXAMPLE 8

A process of preparing a waterproof pigment, comprising the steps of:
(1) mixing 70 parts by volume of water with 5 parts by volume of octanol homogeneously to obtain a mixture A;
(2) adding a coating agent sodium tripolyphosphate to the mixture A with the amount of sodium tripolyphosphate being 5 percent by weight of the mixture A, then completely dissolving stannous chloride to obtain a mixture B;
(3) heating the mixture B to a temperature of 25-45° C., and adjusting pH to a level of 7-9, then adding a primary flake to the mixture B with the amount of primary flake being 2.5 percent by weight of the mixture B, and reacting for 6 hours;
(4) filtering and drying the product of step (3) to obtain the waterproof pigment;

wherein the primary flake has a layered structure of five layers, including a top layer, an assembled intermediate layer and a bottom layer, the assembled intermediate layer has two aluminum layers.

### EXAMPLE 9

The top layer, the bottom layer and the side of the waterproof pigments prepared by Example 1-8 were analyzed through Scanning Electron Microscope (SEM) and Energy Dispersion Spectrum (EDS), and the analysis results were as follows.

TABLE 1

| | Elements of | Elements of | |
|---|---|---|---|
| | the top | the bottom | Elements of the |
| Sample | layer (wt %) | layer (wt %) | side (wt %) |
| Example 1 | O: 8.90 | O: 8.92 | O: 9.74 |
| Example 2 | S: 0.0 | S: 0.0 | S: 0.15 |
| Example 3 | C: 0.0 | C: 0.0 | C: 16.0 |
| Example 4 | P: 0.0 | P: 0.0 | P: 0.1 |
| Example 5 | C: 0.0 | C: 0.0 | C: 24.0 |
| Example 6 | P: 0.0 | P: 0.0 | P: 0.08 |
| Example 7 | Sn: 0.0 | Sn: 0.0 | Sn: 0.11 |
| Example 8 | P: 0.0 | P: 0.0 | P: 0.06 |
| Comparative | O: 8.88; | O: 8.88; | O: 8.88; |
| Example | S: 0.0; | S: 0.0; | S: 0.0; |
| | C: 0.0; | C: 0.0; | C: 0.0; |
| | P: 0.0; | P: 0.0; | P: 0.0; |
| | Sn: 0.0 | Sn: 0.0 | Sn: 0.0 |

Untreated primary flake is used as the control in the comparative example.

It can be seen from the above table that the waterproof pigments prepared by the process of the present invention have a protective layer only on the side of the pigments.

### EXAMPLE 10

10 g of the waterproof pigments prepared by Example 1˜8 were respectively added into an enough amount of a waterborne coating product having a water content of 10%, the volume of released hydrogen was measured after the waterproof pigments had been immersed for 25 h, 50 h and 100 h, and the results were shown in Table 2.

TABLE 2

| | Volume | Volume | |
|---|---|---|---|
| | of H₂ | of H₂ | Volume of |
| | after being | after being | H₂ after being |
| | immersed for | immersed for | immersed for |
| Sample | 25 h (ml) | 50 h (ml) | 100 h (ml) |
| Example 1 | 1.1 | 2.6 | 19 |
| Example 2 | 1.2 | 2.2 | 13 |
| Example 3 | 1.0 | 2.0 | 17 |
| Example 4 | 1.3 | 2.2 | 18 |
| Example 5 | 0.9 | 1.9 | 10 |
| Example 6 | 0.8 | 2.1 | 16 |
| Example 7 | 1.5 | 2.5 | 14 |
| Example 8 | 1.1 | 2.0 | 17 |
| Comparative | 17 | 23 | 24 |
| Example | | | |

Untreated primary flake is used as the control in the comparative example.

It can be seen from the above table that the waterproof pigments prepared by the process of the present invention have much better waterproof property as compared with the untreated pigment.

It is intended that the foregoing examples be regarded as illustrative rather than limiting, although a few examples of this invention have been described in detail above, those skilled in the art will readily appreciate that many modifications are possible without materially departing from the novel teachings and advantages of the invention. It is the following claims, including all equivalents, that are intended to define the spirit and scope of this invention.

1. A waterproof pigment having a primary flake, with the primary flake having a layered structure of at least three layers including a top layer, an assembled intermediate layer and a bottom layer, and the assembled intermediate layer having at least one active metal layer, characterized in that, the waterproof pigment has a coating only on the side of the primary flake.

2. The waterproof pigment as claimed in claim 1, characterized in that, the waterproof pigment has a coating only on the side of the active metal layer.

3. The waterproof pigment as claimed in claim 1, characterized in that, the active metal layer is an aluminum layer or a copper layer.

4. The waterproof pigment as claimed in claim 1, characterized in that, the coating is one selected from the group consisting of fatty acids, salts of fatty acids, amino acids, salts of amino acids, phosphate esters, salts of phosphate esters, alkane sulfonates, polybasic weak acids, salts of polybasic weak acids and organic silicon compounds.

5. The waterproof pigment as claimed in claim 1, characterized in that, the coating is one selected from the group consisting of tin tetrachloride, stannous chloride, zirconium oxychloride, sodium silicate, sodium aluminate, aluminum chloride, bismuth nitrate, calcium chloride and magnesium chloride.

6. The waterproof pigment as claimed in claim 4, characterized in that, the coating is one selected from the group consisting of sulfonates, phosphoric acids, phosphates and polyphosphoric acids.

7. A process of preparing a waterproof pigment comprising the steps of
(1) mixing 70-100 parts by volume of water with 5-40 parts by volume of alcohol or ether homogeneously to obtain a mixture A;
(2) adding a coating agent to the mixture A with the amount of coating agent being between 5 percent and 15 percent by weight of the mixture A, then completely dissolving the coating agent to obtain a mixture B;
(3) heating the mixture B to a temperature of between 25° C. and 45° C., and adjusting pH to a level of between 7 and 9, then adding a primary flake to the mixture B with the amount of primary flake being between 1 percent by weight and 5 percent by weight of the mixture B, and reacting for 0.5-6 hours;
(4) filtering and drying the product of step (3) to obtain the waterproof pigment;
wherein the primary flake has a layered structure of at least three layers, including a top layer, an assembled intermediate layer and a bottom layer, and the assembled intermediate layer has at least one active metal layer.

8. The process of preparing a waterproof pigment as claimed in claim 7, characterized in that, the coating is one selected from the group consisting of fatty acids, salts of fatty acids, amino acids, salts of amino acids, phosphate esters, salts of phosphate esters, alkyl sulfonates, polybasic weak acids, salts of polybasic weak acids and organic silicon compounds.

9. The process of preparing a waterproof pigment as claimed in claim 7, characterized in that, the coating is one selected from the group consisting of tin tetrachloride, stannous chloride, zirconium oxychloride, sodium silicate, sodium aluminate, aluminum chloride, bismuth nitrate, calcium chloride and magnesium chloride.

10. The process of preparing a waterproof pigment as claimed in claim 8, characterized in that, the coating is one selected from the group consisting of sulfonates, polysulfonic acids, phosphoric acids, phosphates and polyphosphoric acids.

11. The process of preparing a waterproof pigment as claimed in claim 7, characterized in that, the active metal layer is an aluminum layer or a copper layer.

12. The use of a waterproof pigment according to claim 1 for the preparing of a water-based coating products, oil-based coating products, paint or printing ink.

13. The waterproof pigment as claimed in claim 2, characterized in that, the active metal layer is an aluminum layer or a copper layer.

14. The waterproof pigment as claimed in claim 2, characterized in that, the coating is one selected from the group consisting of fatty acids, salts of fatty acids, amino acids, salts of amino acids, phosphate esters, salts of phosphate esters, alkane sulfonates, polybasic weak acids, salts of polybasic weak acids and organic silicon compounds.

15. The waterproof pigment as claimed in claim 2, characterized in that, the coating is one selected from the group consisting of tin tetrachloride, stannous chloride, zirconium oxychloride, sodium silicate, sodium aluminate, aluminum chloride, bismuth nitrate, calcium chloride and magnesium chloride.

16. The waterproof pigment as claimed in claim 14, characterized in that, the coating is one selected from the group consisting of sulfonates, phosphoric acids, phosphates and polyphosphoric acids.
